(19) United States
(12) Patent Application Publication
(10) Pub. No.: US 2016/0321584 A1
(43) Pub. Date: Nov. 3, 2016

(54) Device, System, and Method for Team Continuity

(71) Applicant: Avaya Inc., Santa Clara, CA (US)

(72) Inventors: Tony MCCORMACK, Galway (IE); Neil O'CONNOR, Lackagh (IE); Dawid NOWAK, Dublin 15 (IE)

(21) Appl. No.: 14/701,086

(22) Filed: Apr. 30, 2015

(51) Int. Cl. G06Q 10/06

(52) U.S. Cl. CPC G06Q 10/06311

(57) ABSTRACT

A device and method performs a team continuity. The method determines a continuation procedure to continue handling a requested service, the requested service handled by a first team including first members, the continuation procedure determined based upon first attributes of the requested service at a first time and second attributes of the requested service at a second time. The method determines a second team including a second member and at least one of the first members, the second member being exclusive of the first members. The method automatically generates continuation data as a function of the continuation procedure, a progress thereof, the first team, and the second team, the continuation data including hand-off data to transition the handling of the service from the first team to the second team. The method transmits the continuation data to the second team.

### BACKGROUND INFORMATION

A service provider may receive a request from a user for a service handled thereby to be addressed. For example, the service provider may utilize a request receiving feature in which the user provides details and information associated with the request. Subsequently, the service provider may assign an agent to service the request. The service provider may include an automated system that determines the most appropriate and/or qualified agent to be assigned to the service request. In this manner, the service provider may efficiently handle the service being requested from the user.

The service being requested may also entail a plurality of attributes that a single agent is not equipped to handle alone. Therefore, the service provider may assign a team to service the request where the team is two or more agents constituting members thereof. During the course of handling the requested service by the assigned team, the service may require a continuation. The continuation may represent a point in the service where the currently selected team may fall short in handling a remainder of the service. Accordingly, the continuation may entail at least one new member being brought into the team, at least one current member being replaced, or a new team being assigned for the continuation of the service. However, the continuation of the service when a team is assigned the service introduces a complexity issue for efficient management of resources of the service provider, particularly with a continuity and an efficiency in performing this continuity.

### SUMMARY OF THE INVENTION

The present invention describes a method comprising determining, by a team service device, a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed; determining, by the team service device, a second team, the second team including at least one second member of the members and at least one of the first members, the at least one second member being exclusive of the first members; automatically generating, by the team service device, continuation data as a function of the continuation procedure, a progress thereof, the first team, and the second team, the continuation data including hand-off data to transition the handling of the service from the first team to the second team; and transmitting, by the team service device, the continuation data to the second team.

The present invention describes a team service device comprising a transceiver configured to establish a connection to a service provider network of a service provider, the service provider network establishing a further connection to a user device that submits a request for a service; and a processor configured to determine a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed, the processor configured to determine a second team, the second team including at least one second member of the members and at least one of the first members, the at least one second member being exclusive of the first members, the processor configured to automatically generate continuation data as a function of the continuation procedure, a progress thereof, the first team, and the second team, the continuation data including hand-off data to transition the handling of the service from the first team to the second team, the processor configured to transmit the continuation data to the second team.

The present invention describes a non-transitory computer readable storage medium with an executable program stored thereon, wherein the program instructs a microprocessor to perform operations comprising determining a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed; determining a second team, the second team including at least one second member of the members and at least one of the first members, the at least one second member being exclusive of the first members; automatically generating continuation data as a function of the continuation procedure, a progress thereof, the first team, and the second team, the continuation data including hand-off data to transition the handling of the service from the first team to the second team; and transmitting the continuation data to the second team.

### BRIEF DESCRIPTION OF THE DRAWINGS

FIG. 1 shows an exemplary team service device according to the present invention.

FIG. 2 shows an exemplary member pool according to the present invention.

FIG. 3 shows an exemplary method of a continuation according to the present invention.

### DETAILED DESCRIPTION

The exemplary embodiments may be further understood with reference to the following description and the related appended drawings, wherein like elements are provided with the same reference numerals. The exemplary embodiments are related to a device, system, and method for automatic team continuation. Specifically, exemplary embodiments provide a mechanism in which further members or a new team is selected for a service being provided by a current team. Accordingly, the aspects in which a team is formed and selected may be performed in an efficient manner through the exemplary embodiments. The team continuation, the mechanism therefor, the components therefor, and a related method will be described in further detail below.

Initially, it should be noted that the exemplary embodiments described herein may be applicable to a non-real-time scenario as well as a real-time scenario. The non-real-time scenario may be when a user provides information and/or a request to the service provider and the service provider subsequently assigns a team to handle the service at a time at least a predetermined duration after the request was received.

For example, an installation service may require a team to be deployed to a site. Accordingly, such a service is not performed in real-time (e.g., while a user is communicating with the service provider). However, those skilled in the art will understand that the exemplary embodiments may also be used in a real-time scenario. The real-time scenario may be when a user provides information and/or a request to the service provider and the service provider immediately assigns a team to handle the service within the predetermined duration after the request was received. More specifically, the service may be handled while the user is still in a communication session with the service provider. For example, the service provider may include a contact center in which a user may be in real-time contact with a team of agents and has the service provided during the communication session (e.g., voice call, video call, chat session, etc.). With respect to the continuation, this aspect may also be performed as in the real-time scenario in which the service continues to be handled through the continuation. Accordingly, the exemplary embodiments are not restricted to a temporal relationship between a request for a service being received and the service being handled.

When the exemplary embodiments relate to a non-real-time communication, the service provider may utilize a system including a request receiving component from a user device. The request receiving component may be configured to receive information of the user and/or user device and the service for which the request relates. The request may be processed for delivery to further components of the system. The request receiving component may be connected in some manner to a team service device according to the exemplary embodiments as will be described in further detail below. When the exemplary embodiments relate to a real-time communication, the service provider may utilize a system including a contact center network and end devices such as at least one agent device, a supervisor device, etc. The system may also include the team service device according to the exemplary embodiments. Thus, the team may be selected and assigned to the service. The team service device may automatically perform or the team may provide an indication that a continuation procedure is to be performed in both the non-real-time communication and the real-time communication.

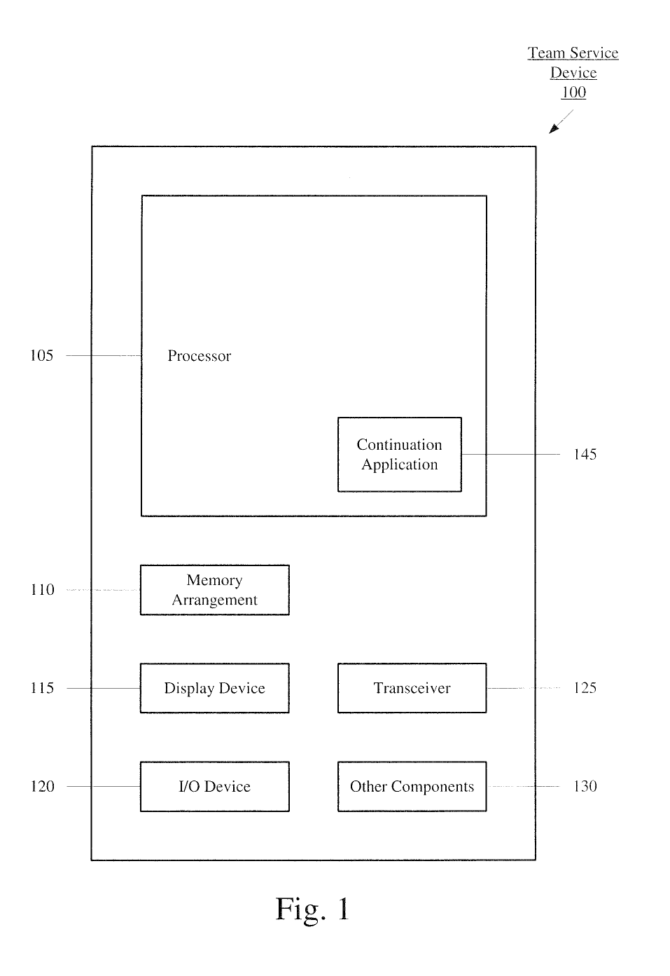

FIG. 1 shows the exemplary team service device 100 according to the present invention. The team service device 100 may be a component in a system of the service provider that performs a variety of functionalities associated with automatic team continuation. The team service device 100 may represent any electronic device that is configured to perform the functionalities described herein. For example, the team service device 100 may be a portable device such as a tablet, a laptop, a smart phone, etc. In another example, the team service device 100 may be a stationary device such as a desktop terminal. The team service device 100 may include a processor 105, a memory arrangement 110, a display device 115, an input/output (I/O) device 120, a transceiver 125, and other components 130 (e.g., an audio input device (for use during the video communication relating to the voice input component), an audio output device (for use during the video communication relating to the voice output component), a battery, a data acquisition device, ports to electrically connect the team service device 100 to other electronic devices, etc.).

The processor 105 may be configured to execute a plurality of applications of the team service device 100. For example, according to the exemplary embodiments, the team service device 100 may execute a formation application if the team service device 100 were equipped with an automatic team formation functionality such as determining a group of members or agents of the service provider who may collectively handle the service. In another example, according to the exemplary embodiments, the team service device 100 may execute a selection application if the team service device 100 were equipped with a team selection functionality such as selecting among the determined teams to be assigned the requested service. However, it should be noted that for purposes of the exemplary embodiments, the initial formation and selection of the team to the requested service may be performed in any manner such as both aspects being performed manually (e.g., by an administrator or manager). In a further example, according to the exemplary embodiments, the team service device 100 may execute a continuation application 145. As will be described in further detail below, the continuation application 145 may receive information of a service being currently handled by a current team assigned thereto and determine a manner of continuing the service being handled through a transfer or conference. Specifically, a member pool including the members or agents of the service provider that forms the basis upon which the teams are determined may be used to determine new or replacement members of a current team to perform the continuation.

It should be noted that the above noted applications, each being an application (e.g., a program) executed by the processor 105, is only exemplary. The functionality associated with the applications may also be represented as a separate incorporated component of the team service device 100 or may be a modular component coupled to the team service device 100, e.g., an integrated circuit with or without firmware.

It should also be noted that the use of the continuation application 145 providing the functionalities herein is only exemplary. For example, as noted above, the continuation application 145 may determine team formations when a change is determined to be needed. However, in another exemplary embodiment, the team formation functionality may be performed by another component or device (e.g., a business process execution application) that provides this information to the continuation application 145. Furthermore, it is noted that the continuation application 145 and/or the other team formation functionality embodiments may utilize further resources beyond what is described herein in orchestrating this operation such as a video conferencing functionality.

The memory 110 may be a hardware component configured to store data related to operations performed by the team service device 100. Specifically, the memory 110 may store data related to the continuation application 145. For example, the team that is currently assigned including information of the service, the members of the team, the team as a whole, etc. may be stored on the memory 110. When the initial team formation and team selection functionality are also performed automatically by the team service device 100, the member pool may also be stored on the memory 110.

The display device 115 may be a hardware component configured to show data to a user while the I/O device 120 may be a hardware component that enables the user to enter inputs. For example, when the team to be assigned to the requested service is performed manually, the member pool may be shown to the user on the display device 115 and the I/O device 120 may enable the user to make selections of the members to be included in the team. It should be noted that the display device 115 and the I/O device 120 may be separate components or integrated together such as a touchscreen. The transceiver 125 may be a hardware component configured to transmit and/or receive data in a wired or wireless manner. The transceiver 125 may operate on a variety of different frequencies or channels (e.g., set of consecutive frequencies) that are related to the functionalities of the different applications being performed.

As described above, a team may initially be assigned to a requested service. Thus, a team formation functionality may relate to determining at least one team from available agents who make up the members of the team. As used herein, the term “agent” and “member” may be used interchangeably when discussing a team. The members of the team may also collectively provide a plurality of attributes. For example, a first team member may be an implementer, a second team member may be a team worker, a third team member may be a plant, etc. Some team members may have more than one attribute such as being an implementer and a plant. The combined set of attributes may form a basis upon whether a team may be qualified or capable of handling a service of the request. For example, if a service requires a first attribute and a second attribute while recommends a third attribute, a selected team must include the first and second attributes and preferably includes the third attribute. When the team service device 100 is configured to perform these functionalities automatically, a determination may be made as to a team that includes all the necessary and preferred criteria to handle the requested service.

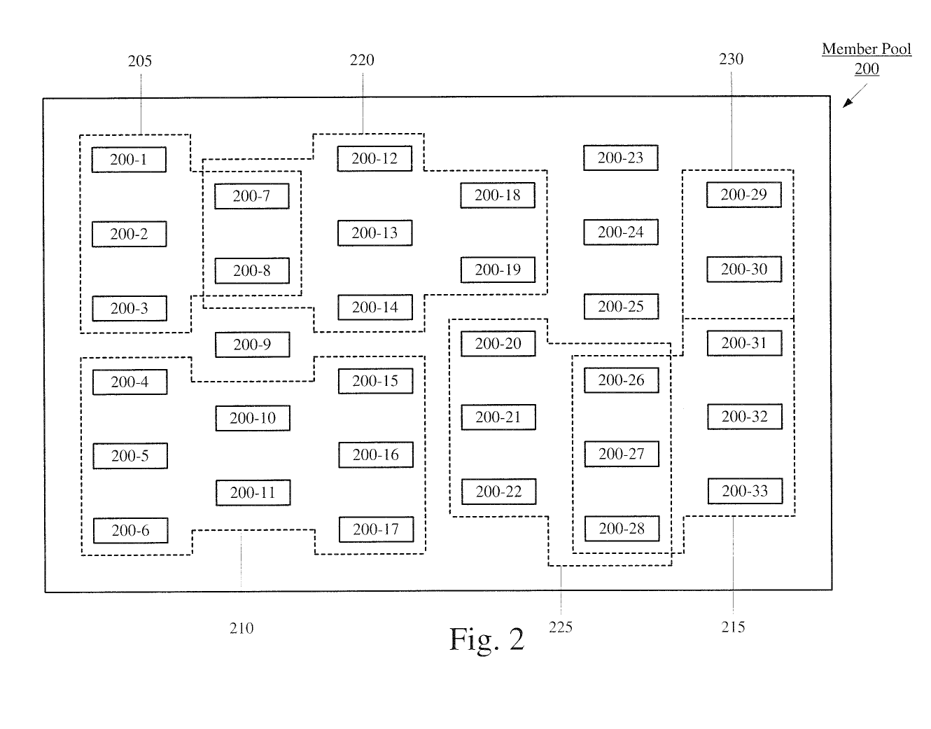

FIG. 2 shows an exemplary member pool 200 according to the present invention. As illustrated, the exemplary member pool 200 may include agents 200-1 to 200-33 who are employed or retained by the service provider. Each agent may have associated attributes. Thus, a combination of select ones of the agents 200-1 to 200-33 may form a team. For example, when the team service device 100 includes an automatic team formation functionality, it may attempt to ascertain teams having a predetermined plurality of attributes corresponding to a requested service. As illustrated, various possible teams that may be determined include a first candidate as team 205, a second candidate as team 210, a third candidate as team 215, and a fourth candidate team as team 220. The team service device 100 may also be configured to highlight these candidate teams 205-220 as possible teams to be assigned to the requested service such that the user may ultimately make a selection of these candidate teams 205-220.

Once the team has been assigned to the requested service, a determination may be made automatically by the team service device 100, a user, a member of the current team, etc. that a continuation procedure is required. Thus, the team service device 100 may perform an automatic team continuation functionality via execution of the continuation application 145. The team continuation functionality may relate to determining a manner in which a service is to be continued from a first team to a second team where the second team may be a incorporating new team members (when the continuation is a conference) or may be a subset of the first team with potentially at least one new member (when the continuation is a transfer). As described above, the first team selected for the service may have been chosen based upon predetermined attributes of the requested service. However, those skilled in the art will understand that during the course of handling the service, further criteria may present itself or a discovery is made that one of the members originally determined to satisfy a particular attribute is no longer capable or available to complete or continue handling the service.

With regard to team formation, there are several types of issues that may become present. In a first example, a team currently assigned to the service may determine that a different team is required in continuing the handling of the requested service. For example, the new team may be a subset of the current team with at least one additional new team member. However, this may require the requested service to be handled anew as the new team members may be unfamiliar with the status of the current service. As illustrated in the member pool 200, a first team may be a team 215. That is, the team 215 may have been selected in handling the requested service. However, a continuation may have been determined to be needed in which a subset of the team 215 and several new members are to constitute a newly assembled team. For example, the new team may be a team 225 including members 200-26, 200-27, 200-28 (the subset of the team 215) and members 200-20, 200-21, 200-22 (the new members).

In a second example, a team currently assigned to the requested service may determine that the team requires new team members in continuing the handling of the service. For example, the original predetermined required attributes may have omitted a further required attribute or a discovery is made that the further required attribute is required. However, this may impact efficiency in completing the service since the new team members may be unfamiliar with the status of the current service. As illustrated in the member pool 200, a first team may be the team 215. However, a continuation may have been determined to be needed in which new members are to be added to the team 215. Thus, a newly assembled team may include the first team 215 and a second “team” 230 which include the new members. Thus, the new team may include teams 215, 230 including members 200-26, 200-27, 200-28, 200-31, 200-32, 200-33 (team 215) and members 200-29, 200-30 (team 230).

In a third example, an entirety of the members of the team currently assigned to the requested service may no longer be required in continuing the handling of the service. For example, the service may include a plurality of stages in which a first stage may require a first set of attributes, a second stage may require a second set of attributes different from the first set of attributes, etc. However, due to the handling still being part of a single service, there may be benefits to efficiency when at least one of the first team (e.g., of the first stage) remains at least temporarily (or even permanently) in the second team (e.g., of the second stage) to improve the transition. Otherwise, the efficiency may be substantially impacted due to a new team being introduced to the service without pertinent information that the prior team may have.

Although not as impactful as adding new members, in a third example, a team currently assigned to the service may no longer require one or more members as the portion of the service where these members are required have been completed or are otherwise determined to not be needed. For example, the team 215 that was assigned to handle the requested service may no longer require members 200-31, 200-32, 200-33. Thus, these members may be removed from the group in the continuation procedure to free up the resources of the service provider. The continuation procedure may still benefit from improved efficiency when the redistribution of responsibilities are determined by the team service device 100 for the remaining members of the team.

Due to this efficiency impacting reason when a continuation operation is determined to be needed, the continuation application 145 according to the exemplary embodiments provide a mechanism to seamlessly introduce new members such as providing information and instructions to new members of the team and/or update prior team members as to how the new assembled team is to complete the service. That is, the continuation application 145 may orchestrate the continuation functionality as a conference or transfer operation. The result of such orchestration may be analogous to an operation of invoking a conference or transfer session, but further involves other orchestration features. In a first example, the continuation application 145 may select the subset of the current team that is to be included in the newly assembled team as in the case of a transfer. In a second example, the continuation application 145 may select the new team members to be included in the newly assembled team as in the case of a transfer or a conference. In a third example, the continuation application 145 may notify the newly assembled team including the original members and the new members in a transfer of the new collaboration session details such as the jobs to be assigned each member in completing the service. In a fourth example, the continuation application 145 may notify the new team members to be included in the newly assembled team in a conference of the existing collaboration session details. Using the above features, the continuation application 145 may enable the seamless continuation and maintain the efficiency in completing the service.

In a particular example for a continuation operation to be performed, a first team may be a logistics team. The logistics team may have completed its work related to the service. A subsequent step may be to transfer the interaction to an execution team. In this example, it may be assumed that the members of the logistics team does not have nor require knowledge of who is selected in the formation of the execution team. The specific intricacies in this case may relate to the options for controlling a transfer. For example, the transfer may not be allowed to complete until a certain cohort (subject to rules) of the execution team have accepted the incoming transfer. In another example, at least one member of the logistics team may be required to remain with the interaction for continuity progress such as a team leader. In a further example, the transfer may remain pending until a specified execution resource (e.g., identified ad-hoc by one of the logistics team) has accepted the transfer. In yet a further example, a combination of the above intricacies may be used. When the above criteria are satisfied in transferring the service from the logistics team to the execution team, a hand-off may be performed in a seamless manner rather than as a disjointed activity whereby a new team is formed as a new task.

It should be noted that the continuation application 145 may contribute in further defining a manner in which subsequent team assignments to services are performed. Specifically, the continuation application 145 may provide reporting and analytics where this information relating to conferences and transfers enable the service provider or analysts to understand where service processes are to be tuned. For example, the information of the continuation application 145 may reduce a number of incidences when a conference operation or a transfer operation are to be used or required. In another example, potentially erroneous behavior that may particularly occur in a real-time environment such as in a contact center may be reduced as well.

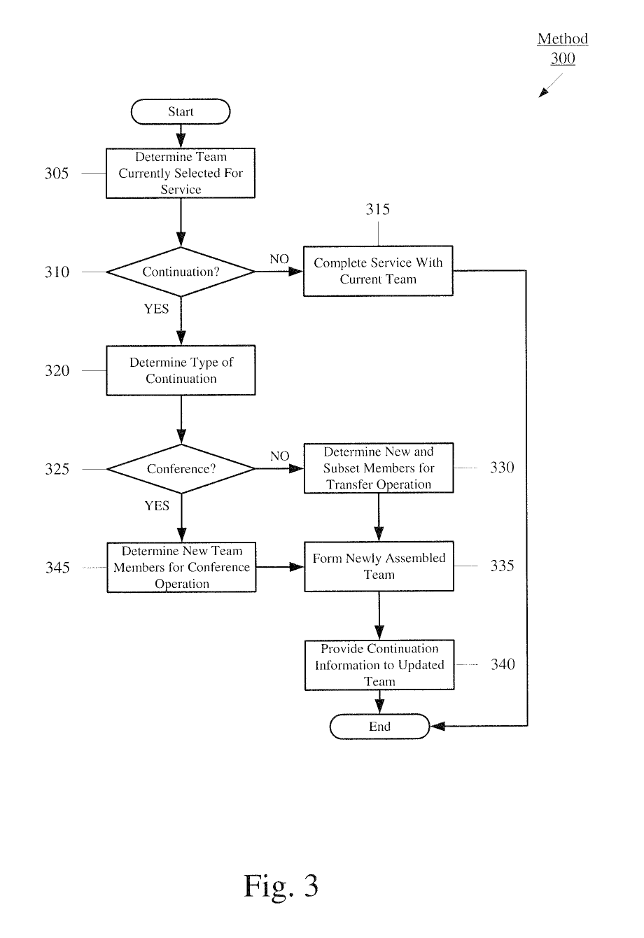

FIG. 3 shows an exemplary method 300 of a continuation according to the present invention. Specifically, the method 500 may relate to an execution of the continuation application 145 so that a continuation operation may be performed as with a transfer or a conference. Because the team continuation functionality relates to a point in time after the handling of the requested service has already begun, it may be assumed that an original team has already been assigned in handling the requested service. The method 500 will be described with regard to the team service device 100 of FIG. 1 and the member pool 200 of FIG. 2.

In step 505, the continuation application 145 of the team service device 100 may determine the original team currently selected to handle the service. The continuation application 145 may determine or receive information (e.g., from the original team) that a continuation may be required. If a continuation is not needed, the continuation application 145 continues the method 500 to step 515. In step 515, the original team is allowed to complete the service. However, if a continuation is needed, the continuation application 145 continues the method 500 to step 520.

In step 520, the continuation application 145 determines whether the continuation is a transfer or a conference. As discussed above, the transfer may be when a newly assembled team is created including a subset of the original team and at least one new member whereas the conference may be when a newly assembled team is created including the original team and at least one new member. The transfer may occur when, for example, the required attributes that were originally determined to be necessary has changed or the flow of the process in handling the services has altered the required attributes. Thus, members of the original team may be removed leaving only a subset but also include new members to complete the contribution of the attributes. The conference may occur when, for example, the required attributes that were originally determined to be necessary has omitted other required attributes that are later discovered. Thus, members of the original team are supplemented with new members to complete the contribution to the newly discovered required attributes.

In step 525, the continuation application 145 determines whether the type of continuation is a conference. If the continuation is a transfer, the continuation application 145 continues the method 500 to step 530. In step 530, the continuation application 145 determines the new members to be added to the newly assembled team and the remaining subset of members from the original team to be included in the newly assembled team. When determining the type of continuation, the continuation application 145 may have determined the updated required attributes needed in the newly assembled team. This may form the basis for the continuation application 145 in determining the new members and the subset members. In step 535, the continuation application 145 forms the newly assembled team. In step 540, the continuation application 145 provides continuation information to the updated team such that a seamless transition may occur to maintain an efficiency in continuing the handling of the service already in progress.

Returning to step 525, if the continuation application 145 determines that the type of continuation is a conference, the continuation application 145 continues the method 500 to step 545. In step 545, the continuation application 145 determines the new team members to be added to the original team to create a newly assembled team. Again, when determining the type of continuation, the continuation application 145 may have determined the additional required attributes needed which forms the basis in determining the new members. Subsequently, the continuation application 145 may continue the method 500 to step 535 and 540.

The exemplary embodiments provide a device, system, and method of forming teams in handling a requested service of a service provider. The team may be formed based upon a variety of factors such as attributes associated with the service. The team which includes a plurality of members may collectively include the attributes among other further attributes. While the service is being handled, there may be instances when a continuation process is required. The exemplary embodiments may additionally be configured to seamless transition the continuation from the original team to a newly assembled team.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
determining, by a team service device, a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed;
determining, by the team service device, a second team, the second team including at least one second member of the members and at least one of the first members, the at least one second member being exclusive of the first members;
automatically generating, by the team service device, continuation data as a function of the continuation procedure, a progress thereof, the first team, and the second team, the continuation data including hand-off data to transition the handling of the service from the first team to the second team; and
transmitting, by the team service device, the continuation data to the second team.

2. The method of claim 1, wherein the continuation procedure is one of a transfer and a conference.

3. The method of claim 2, wherein, when the continuation procedure is the transfer, the at least one of the first members is a subset of the first members of the first team.

4. The method of claim 2, wherein, when the continuation procedure is the conference, the at least one of the first members is an entirety of the first members of the first team.

5. The method of claim 2, wherein, when the continuation procedure is the transfer, the second set of attributes is a subset of the first set of attributes and at least one further attribute.

6. The method of claim 2, wherein, when the continuation procedure is the conference, the second set of attributes includes at least one additional attribute relative to the first set of attributes.

7. The method of claim 3, wherein the subset of the first members is included in the second team one of permanently and temporarily.

8. The method of claim 1, further comprising:
generating, by the team service device, at least one of reporting data and analytics data indicative of subsequent team assignments to be tuned to minimize a number of times the continuation procedure is performed.

9. The method of claim 1, wherein the hand-off data includes responsibility assignments to the at least one second member and the at least one of the first members of the second team.

10. The method of claim 1, wherein the requested service is handled one of in real-time and in non-real-time.

11. A team service device, comprising:
a transceiver configured to establish a connection to a service provider network of a service provider, the service provider network establishing a further connection to a user device that submits a request for a service; and
a processor configured to determine a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed, the processor configured to determine a second team, the second team including at least one second member of the members and at least one of the first members, the at least one second member being exclusive of the first members, the processor configured to automatically generate continuation data as a function of the continuation procedure, a progress thereof, the first team, and the second team, the continuation data including hand-off data to transition the handling of the service from the first team to the second team, the processor configured to transmit the continuation data to the second team.

12. The team service device of claim 11, wherein the continuation procedure is one of a transfer and a conference.

13. The team service device of claim 12, wherein, when the continuation procedure is the transfer, the at least one of the first members is a subset of the first members of the first team.

14. The team service device of claim 12, wherein, when the continuation procedure is the conference, the at least one of the first members is an entirety of the first members of the first team.

15. The team service device of claim 12, wherein, when the continuation procedure is the transfer, the second set of attributes is a subset of the first set of attributes and at least one further attribute.

16. The team service device of claim 12, wherein, when the continuation procedure is the conference, the second set of attributes includes at least one additional attribute relative to the first set of attributes.

17. The team service device of claim 13, wherein the subset of the first members is included in the second team one of permanently and temporarily.

18. The team service device of claim 11, wherein the processor is further configured to generate at least one of reporting data and analytics data indicative of subsequent team assignments to be tuned to minimize a number of times the continuation procedure is performed.

19. The team service device of claim 11, wherein the hand-off data includes responsibility assignments to the at least one second member and the at least one of the first members of the second team.

20. A non-transitory computer readable storage medium with an executable program stored thereon, wherein the program instructs a microprocessor to perform operations comprising:
determining a continuation procedure to be performed in continuing of a handling of a requested service by a service provider, the requested service being handled by a first team including first members of a plurality of members of the service provider, the continuation procedure determined based upon a first set of attributes of the requested service and a second set of attributes of the requested service, the first set of attributes corresponding to a first time prior to the continuation procedure being performed and the second set of attributes corresponding to a second time subsequent to the continuation procedure being performed;
determining a second team, the second team including at least one second member of the members and at least one of the first members, the at least one second member being exclusive of the first members;
automatically generating continuation data as a function of the continuation procedure, a progress thereof, the first team, and the second team, the continuation data including hand-off data to transition the handling of the service from the first team to the second team; and
transmitting the continuation data to the second team.
